(19) United States
(12) Patent Application Publication
(10) Pub. No.: US 2020/0262606 A1
(43) Pub. Date: Aug. 20, 2020

(54) PACKAGING

(71) Applicant: NICOVENTURES HOLDINGS LIMITED, LONDON (GB)

(72) Inventors: James SWEENEY, London (GB); Richard YOUNG, London (GB)

(21) Appl. No.: 16/651,513

(22) PCT Filed: Oct. 1, 2018
(86) PCT No.: PCT/GB2018/052798

§ 371 Date: Mar. 27, 2020

(30) Foreign Application Priority Data
Sep. 29, 2017 (GB) 1715901.3

(51) Int. Cl. B65D 5/54; B65D 5/38; B65D 5/50; B65D 5/66; B31B 50/26

(52) U.S. Cl. CPC B65D 5/5445; B65D 5/38; B31B 2120/60; B65D 5/6608; B31B 50/26; B65D 5/503

(57) ABSTRACT

A display carton includes a base tray having upstanding front, side and rear walls and a cover which is detachably connected to the base tray along lines of weakness. The cover includes an inner front wall positioned above the front wall of the base tray and an outer front wall which is provided by a distal end of a forwardly extending lid of the cover. The inner front wall comprises left and right portions which are connected together by a line of weakness. A bottom end of the outer front wall is tucked into a slot formed between a bottom edge of the inner front wall and a top edge of the front wall of the base tray.

### PRIORITY CLAIM

The present application is a National Phase entry of PCT Application No. PCT/GB2018/052798, filed Oct. 1, 2018, which claims priority from GB Patent Application No. 1715901.3, filed Sep. 29, 2017, each of which is hereby fully incorporated herein by reference.

### TECHNICAL FIELD

The present disclosure relates to packaging.

### BACKGROUND

Packaging may be used to protect a product prior to use by a user and to contain ancillary item(s) related to the product that will be needed by the user when using the product. For example, when the product is a vaping device, the packaging may contain the vaping device and an ancillary item such as a charger for the vaping device.

A product and an ancillary item may be stored in a box-like container. A plurality of box-like containers may need to be stored in a display carton for the purpose of being transported to a sale or use location, with the display carton being re-configurable at the sale or use location to display the box-like containers.

### SUMMARY

According to some embodiments described herein, there is provided a display carton comprising: a base tray having upstanding front, side and rear walls; and a cover which is detachably connected to the base tray along lines of weakness, the cover including (i) an inner front wall positioned above the front wall of the base tray and (ii) an outer front wall which is provided by a distal end of a forwardly extending lid of the cover; wherein the inner front wall comprises left and right portions which are connected together by a line of weakness; and a bottom end of the outer front wall is tucked into a slot formed between a bottom edge of the inner front wall and a top edge of the front wall of the base tray.

The display carton may provide a structurally rigid carton for the purpose of transporting the contents of the display carton (e.g. box-like containers) to a sale or use location. The left and right portions of the inner front wall (when still connected together across the line of weakness) may provide a structurally-rigid upper front part of the display carton during transport. When the display carton arrives at the sale or use location, the cover may be removed from the base tray, and part of the this removal operation may be achieved by separating the left and right portions of the inner front wall from each other by rupturing the line of weakness which was previously connecting them together.

In some embodiments, the slot has a triangular shape.

A triangular shape may make it easier to tuck the bottom end of the outer front wall into the slot when closing the lid of the display carton because the triangular shape may act as a guide for the bottom end of the outer front wall.

In some embodiments, bottom edges of the left and right portions of the inner front wall of the cover slope upwards and meet at the bottom end of the line of weakness connecting together the left and right portions of the inner front wall.

In this way, the vertical height of the line of weakness connecting together the left and right portions of the inner front wall may be reduced, which reduces the amount of rupturing of lines of weakness needed when removing the cover from the base tray.

In some embodiments, the top edge of the front wall of the base tray is substantially horizontal.

When the cover has been removed from the base tray, the top edge of the front wall of the base tray may present a pleasing visual appearance by being substantially horizontal.

In some embodiments, the cover has first and second side walls each having a bottom edge connected by a respective one of the lines of weakness to a top edge of a respective one of the side walls of the base tray.

In some embodiments, the first and second side walls of the cover are each connected at a top edge to a respective flap which is pivotable between a position in which the flap extends inwards to be underneath the lid of the cover and a position, when the lid has been opened, in which the flap extends outwards away from the lid.

The flaps of the cover may help to prevent the entry of dust or dirt into the display carton prior to the point in time when the cover is removed from the base tray.

In some embodiments, the rear wall of the base tray is taller than the front wall of the base tray; and top edges of the side walls of the base tray each slope downwards from the rear wall to the front wall of the base tray.

In some embodiments, a rear wall of the cover is hingedly connected to a proximal end of the lid of the cover and is connected by one of the lines of weakness to a top edge of the rear wall of the base tray.

Prior to the cover being removed from the base tray by rupturing the lines of weakness, the cover may be provided with circumferential structural continuity (and thus circumferential rigidity) by means of: the left and right portions of the inner front wall, side walls of the cover, and a rear wall of the cover.

In some embodiments, there is provided packaging comprising the display carton and a plurality of box-like product kits which are stored one in front of another inside the display carton.

In some embodiments, the height of each product kit matches the inside height of the closed display carton and the width of each product kit matches the inside width of the display carton, and the combined depths of the product kits matches the inside depth of the display carton between the front and rear walls of the base tray of the display carton.

In this way, the product kits may fill the internal volume of the display carton during transport to a sale or use location.

In some embodiments, there is provided a blank for forming the display carton.

In some embodiments, there is provided a method of forming a display carton, comprising: providing a blank for a display carton; and folding the blank to form the display carton.

### BRIEF DESCRIPTION OF THE DRAWINGS

Embodiments of the disclosure will now be described, by way of example only, with reference to the accompanying drawings, in which:

FIG. 1 is a schematic representation of how packaging in accordance with a first embodiment may be opened up by lifting a lid of a cover of a display carton, by lifting a kit (a container in a sleeve, with a booklet attached to the front of the container, and a product and an ancillary item inside the container) out of the display carton, by opening the kit by lifting the container out of the sleeve, by removing the booklet from the front of the container, and by opening the container to remove the product and the ancillary item.

FIG. 2 is a perspective view of the packaging of the first embodiment when fully closed up.

FIG. 3A is an exploded perspective view of the packaging of the first embodiment with the lid of the cover of the display carton having been opened, and a kit lifted out of the display carton and opened by removing a security seal from across the top end of the sleeve to enable the container to be lifted up out of the sleeve.

FIG. 3B is a perspective view of the packaging of the first embodiment when the cover of the display carton has been completely removed so as to expose all of the kits sitting in a base tray of the display carton.

FIGS. 4 to 10 are respectively perspective, front, rear, right side, left side, top and bottom views of the display carton of the first embodiment, wherein the display carton is shown with the lid raised and left and right portions of an inner front wall of the cover having been separated apart along a vertical line of weakness.

FIG. 11 is a plan view of the blank used to form the display carton of the first embodiment.

FIGS. 12 to 18 are respectively perspective, front, rear, left side, right side, top and bottom views of the container of the first embodiment, wherein the container is shown with a front flap of the container swung to an open position and with no product in the wells of a tray of the container.

FIG. 19 is a plan view of the blank used to form the container of the first embodiment.

FIG. 20 is a plan view of the blank used to form the sleeve of the first embodiment.

FIG. 21 is a perspective view of the display carton of the first embodiment similar to that of FIG. 4 but showing the left and right portions of the inner front wall of the cover still joined together along a vertical line of weakness

FIG. 22 is a perspective view of the container of the first embodiment similar to that of FIG. 12 but without the tray inside the container and with a locking tab at the top of the rear wall of the container unlocked from a top panel of a box of the container.

FIGS. 23 and 24 are rear perspective views of the container of the first embodiment showing an initial stage (FIG. 23) of accessing the top of the tray in the container and a later stage (FIG. 24) when the tray has been partially raised up out of the container to give access to a second compartment behind the tray in which an ancillary item may be stored.

### DETAILED DESCRIPTION

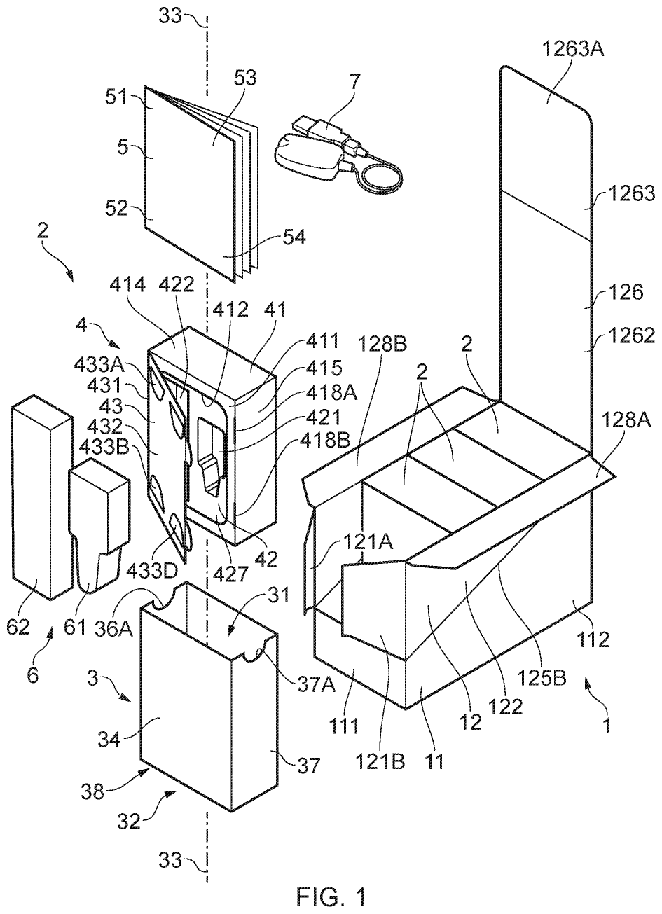

The first embodiment of the packaging shown in FIG. 1 of the drawings comprises a display carton 1 and four product kits 2 which fit inside the display carton 1. The length of the display carton 1 from front to back may be varied in order to accommodate a different number of kits 2.

In FIG. 1, three of the kits 2 are still in the display carton 1. The forward-most kit 2 has been removed from the display carton 1 and taken apart to show the major components of the kit 2, which are a sleeve 3 which has an open top end 31 and a closed bottom end 32; a container 4 which is slidably insertable into and removable from the open top end 31 along an insertion/removal axis 33 of the sleeve 3; a printed document 5 (such as a booklet) which is removably secured to the container 4 when the container 4 is in the sleeve 3, and which (as shown in FIG. 1) may be separated from the container 4 when the container 4 has been lifted out of the sleeve 3; a product 6 (such as a vaping device) which in FIG. 1 is diagrammatically shown as comprising first and second parts 61, 62; and an ancillary item 7 such as a charger for the product 6. As will be explained later, the product 6 and the ancillary item 7 may be stored in respective front and rear compartments of the container 4.

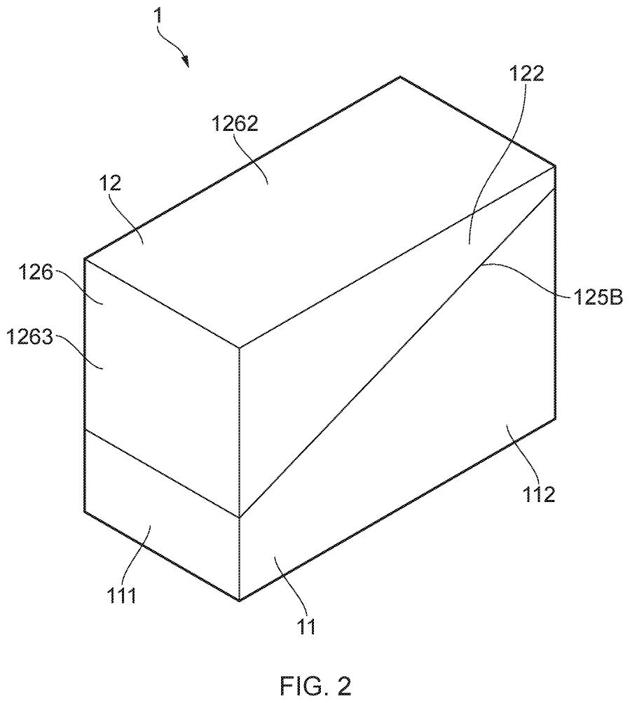

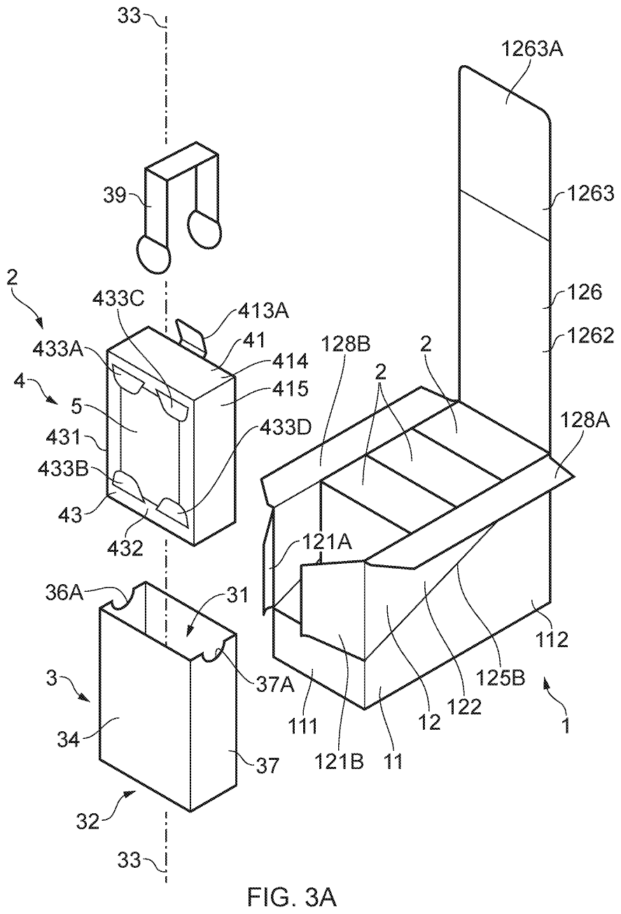

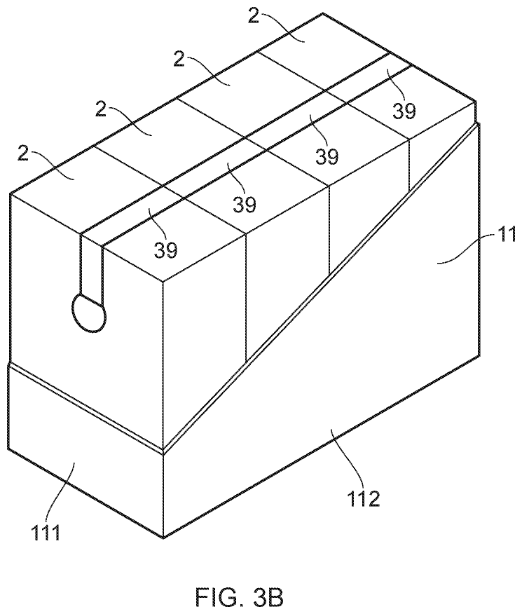

FIG. 2 shows the closed (initial) configuration of the packaging of the first embodiment. This configuration may be adopted when the kits 2 are travelling from the factory to the location of intended sale or use. At that location, the display carton 1 may be partially opened up (as shown in FIG. 3A). The display carton 1 may be fully opened up to adopt a final configuration (as shown in FIG. 3B and as will be explained in more detail later on) so that the individual kits 2 may be removed and sold or used.

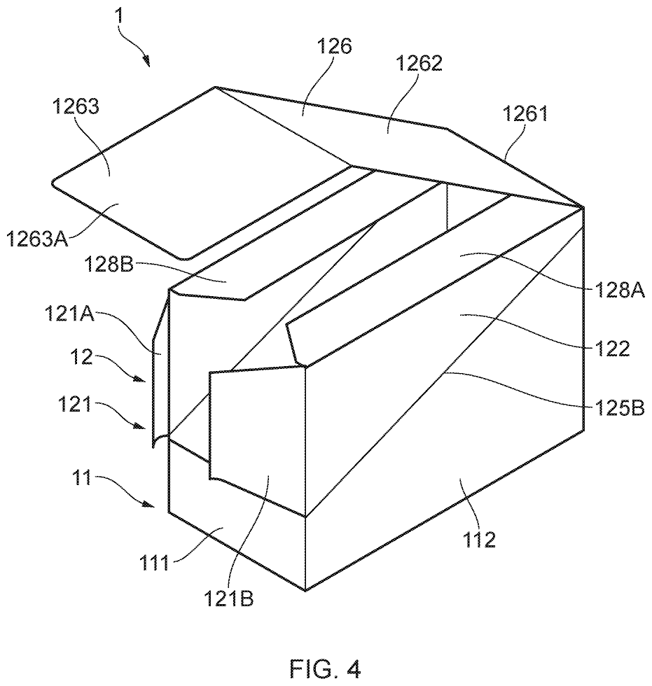

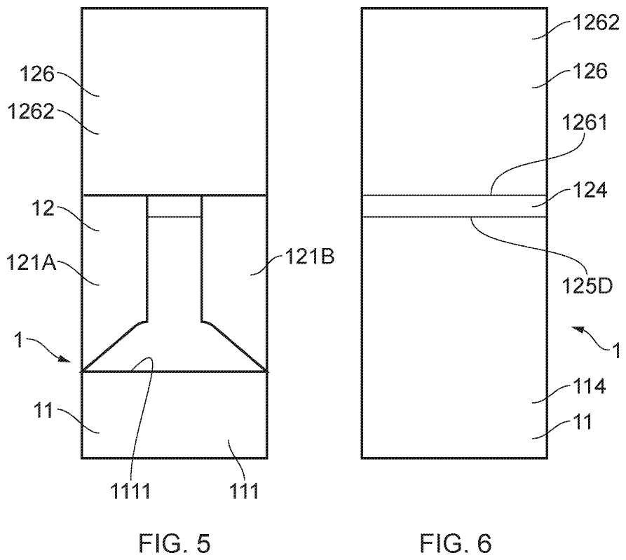

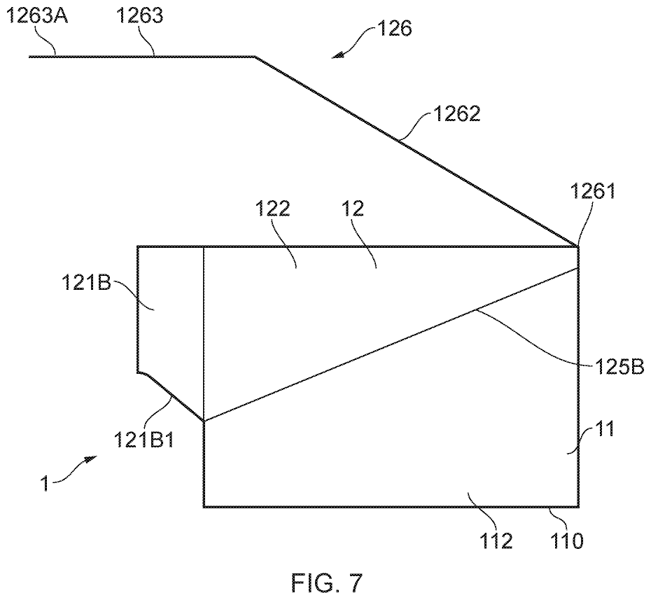

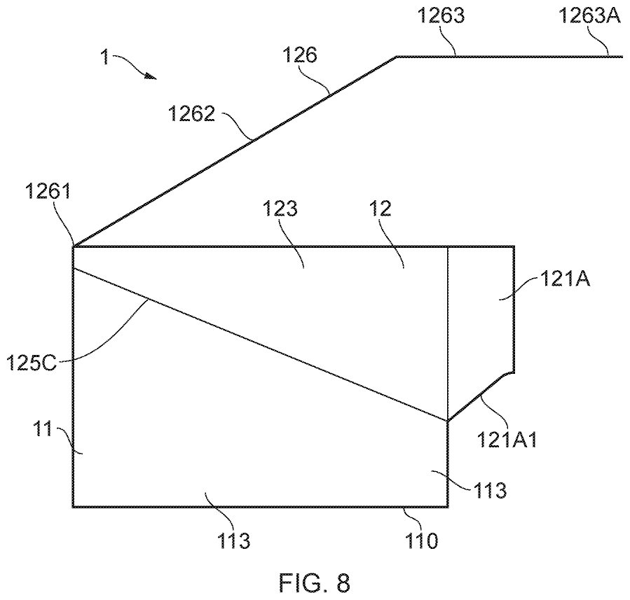

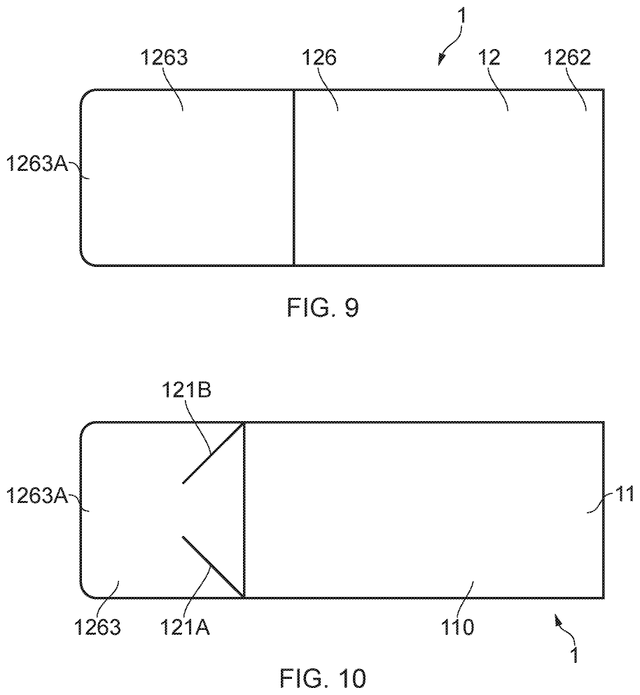

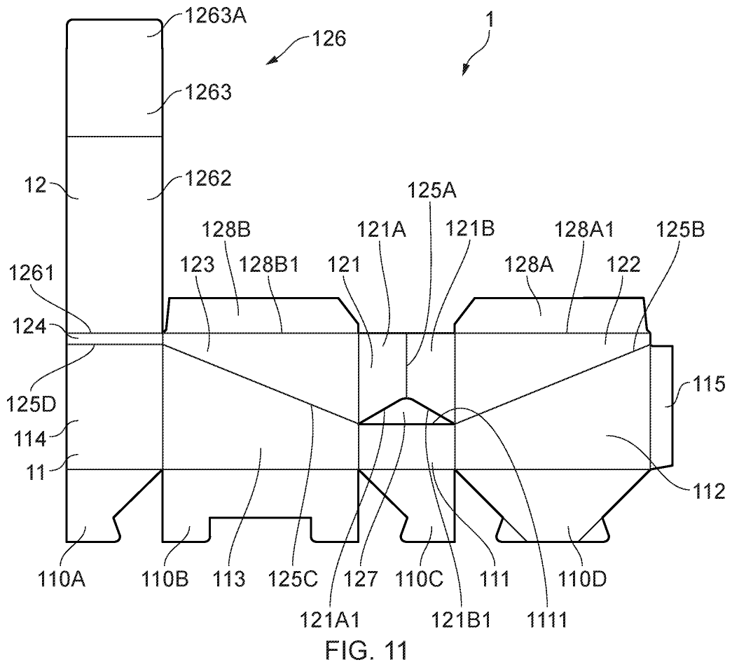

The display carton 1 will now be described in more detail with reference to FIGS. 4 to 10 which are respectively perspective, front, rear, right side, left side, top and bottom views of the display carton 1. Reference will also be made to FIG. 11 which shows a single blank which is made of thin card and which may be folded up to form the display carton 1.

The display carton 1 comprises a base tray 11 and a cover 12 which is detachably connected to the base tray 11.

The base tray 11 comprises a floor 110 (see FIG. 10) and a front wall 111, first side wall 112, second side wall 113 and rear wall 114 which project upwards from the floor 110. The floor 110 (see the blank shown in FIG. 11) is made up of four sections 110A-D which lock together as the blank is folded up to form the display carton 1.

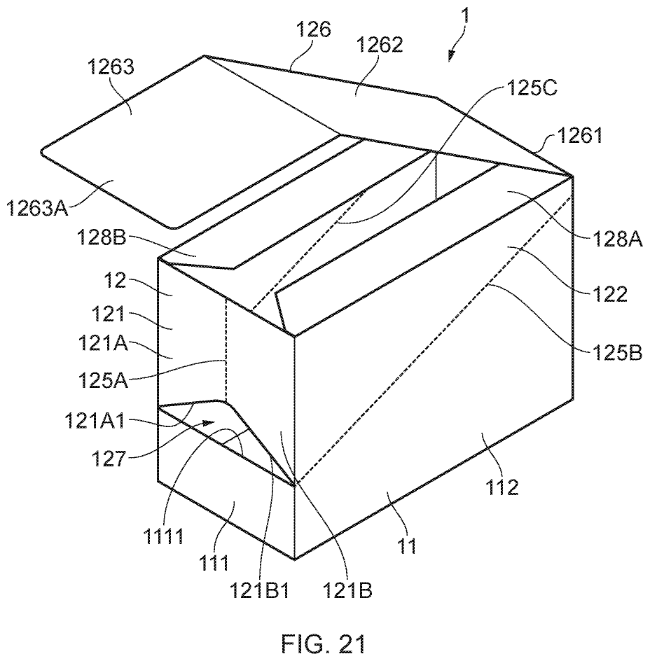

The cover 12 comprises a (first or inner) front wall 121, first side wall 122, second side wall 123 and rear wall 124 which are positioned respectively above the front wall 111, first side wall 112, second side wall 113 and rear wall 114 of the base tray 11. The first or inner front wall 121 comprises left and right portions 121A, 121B which are initially connected together by a line of weakness 125A (see the blank shown in FIG. 11 and the perspective view of the display carton shown in FIG. 21). In FIGS. 4 to 10, the line of weakness 125A has been ruptured, and the left and right portions 121A, 121B are shown as having been swung slightly forwards.

The cover 12 also comprises a lid 126 which is connected by a hinge 1261 to the top of the rear wall 124 of the cover so as to project forwards from the rear wall 124 when the lid is closed. The lid 126 comprises a first or proximal panel 1262 which forms a top wall of the cover 12 when the lid is closed, and a second or distal panel 1263 which forms an outer or second front wall when the lid is closed (as shown in FIG. 2 for example).

When the lid 126 is closed, the bottom (distal) end 1263A of the panel 1263 tucks into a triangular slot 127 (see FIG. 21) which exists between the horizontal top edge 1111 of the front wall 111 of the base tray 11 and the bottom edges 121A1, 121B1 of the left and right portions 121A, 121B of the inner front wall 121 of the cover 12. The edges 121A1, 121B1 slope upwards in a symmetrical manner towards the line of weakness 125A so that the line of weakness 125A is centrally positioned as a vertical line of weakness of the inner front wall 121.

The cover 12 includes first and second side flaps 128A, 128B which are pivotably connected by respective hinges 128A1, 128B1 to the top edges of the first and second side walls 122, 123 to as to be pivotable between pointing inwards (e.g. in FIG. 4) and pointing outwards (e.g. in FIG. 1).

The display carton 1 also includes lines of weakness 125B, 125C, 125D which detachably connect the cover 12 to the base tray 11.

The line of weakness 125B connects a top edge of the first side wall 112 of the base tray to the bottom edge of the first side wall 122 of the cover.

The line of weakness 125C connects a top edge of the second side wall 113 of the base tray to the bottom edge of the second side wall 123 of the cover.

The line of weakness 125D connects a top edge of the rear wall 114 of the base tray to the bottom edge of the rear wall 124 of the cover.

Rupturing these three lines of weakness 125B, 125C, 125D had the effect of separating the cover 12 from the base tray 11.

During the act of removing the cover 12 from the base tray 11, the rough handling involved is likely also to rupture the vertical line of weakness 125A which connects together the left and right portions 121A, 121B of the inner front wall 121 of the cover 12. Up until this point in time, the inner front wall 121 has served to provide structural rigidity to the front of the display carton 1 by structurally linking together the first and second side walls 122, 123 of the cover 12. However, when the display carton is being prepared to display the kits 2, the cover 12 is no longer needed, and there is no longer any need for structural rigidity of the disposable upper portion (the cover 12) of the display carton.

With the cover 12 removed, the display carton 1 now comprises only the base tray 11 (see FIG. 3B) for presenting the kits 2 for display for purchase or use. Because the rear wall 114 of the base tray is taller than the front wall 111, the top edges of the side walls 112, 113 of the base tray slope downwards from the rear wall to the front wall of the base tray, and thus the base tray intuitively presents the kit 2 which is adjacent to the front wall 111 as being the kit that may be presented towards the intended purchasers or users.

The blank of the display carton 1 (see FIG. 11) incorporates an extension 115 attached to the first side wall 112 of the base tray 11, and this extension may be provided with adhesive so that, when the blank is folded up to form the display carton, the extension 115 forms an adhesive connection between the first side wall 112 and the rear wall 114 of the base tray 11.

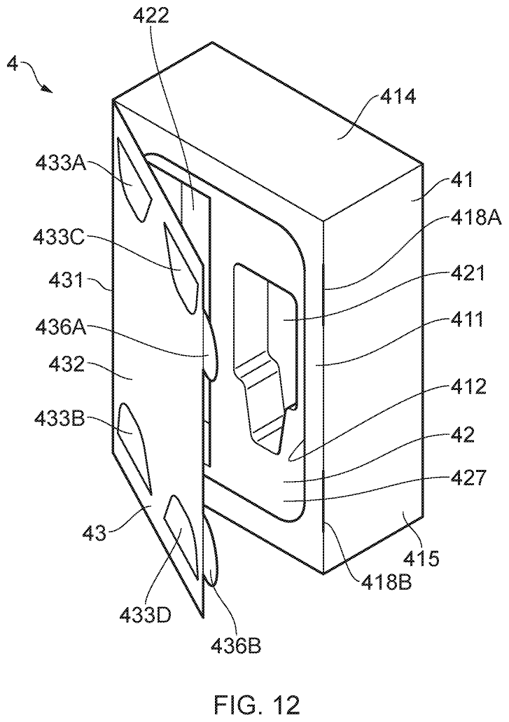

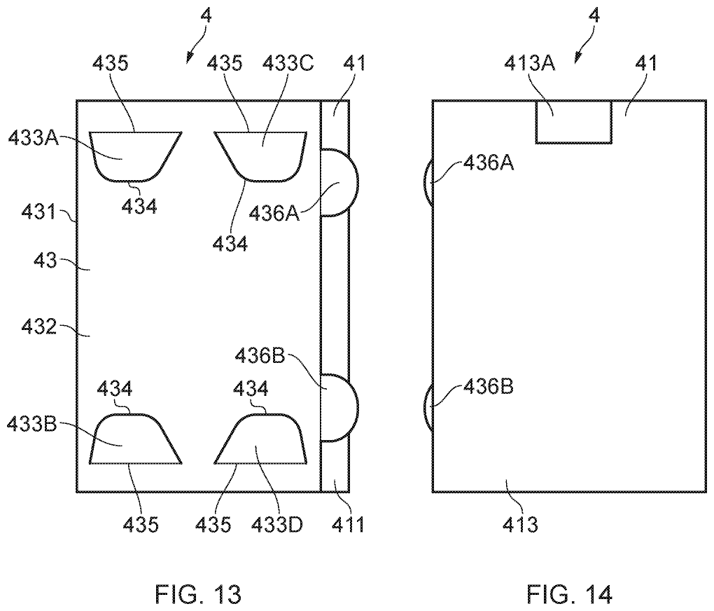

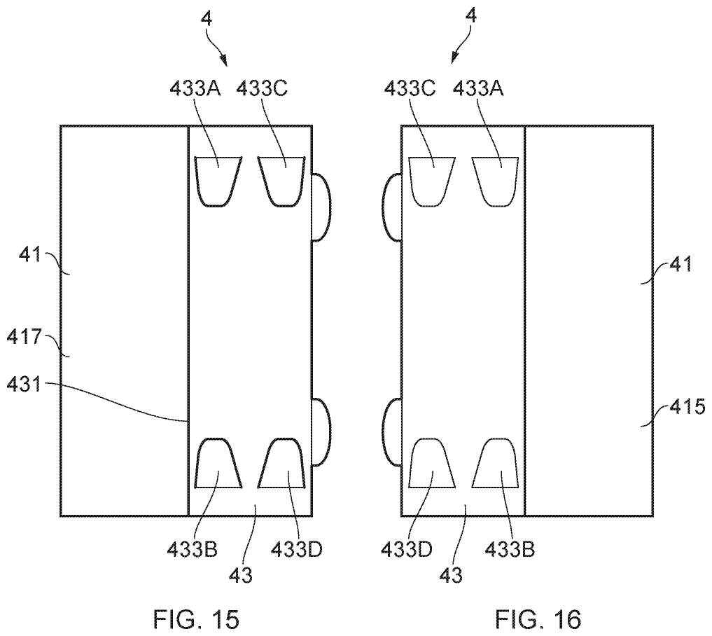

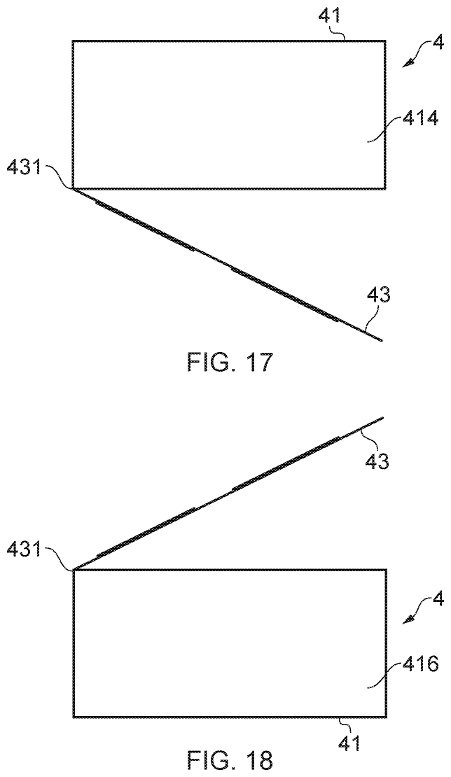

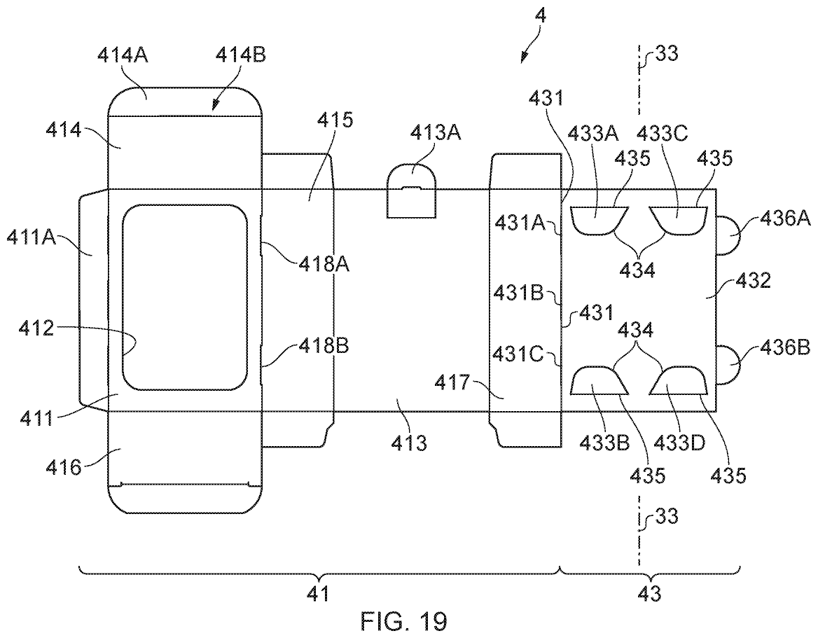

The container 4 will now be described in more detail with reference to FIGS. 12 to 18 which are respectively perspective, front, rear, left side, right side, top and bottom views of the container 4. Reference will also be made to FIG. 19 which shows a single blank which is made of thin card and which may be folded up to form a box 41 and a front flap 43 of the container 4.

The container 4 comprises the box 41, a tray 42 inside the box 41, and the front flap 43 which is pivotably connected at a hinge line 431 to the box 41. In FIGS. 12 to 18, the container 4 is shown with the front flap 43 swung to an open position and with no product stored in the tray 42. In FIG. 3A, the front flap 43 is closed.

The container 4 is re-configurable between a folded-together (closed) configuration in which the front flap 43 rests against a front main panel 411 of the box 41 and the container 4 is insertable into and removable from the sleeve 3 via the open or top end 31 of the sleeve 3 along the insertion/removal axis 33 (see FIG. 3A) and an unfolded (open) configuration in which an aperture 412 in the front panel 411 of the box 41 is accessible to give access to first and second wells 421, 422 of the tray 42 which provide a first or front compartment of the box 41 (see FIG. 12). The first well 421 is intended to receive the first part 61 of the product 6, and the second well 422 is intended to receive the second part 62 of the product 6. The box 41 and front flap 43 are folded together from the blank shown in FIG. 19.

The box 41 includes the front main panel 411, a rear main panel 413 and first to fourth edge panels 414-417. The first edge panel 414 is at the top of the box 41 and it is in the form of a closeable flap which provides access into the box 41. The first edge panel 414 is connected to an extension 414A via a fold line which incorporates a slit 414B. A locking tab 413A at the top edge of the rear panel 413 may engage with the slit 414B to hold the first edge panel 414 shut.

The blank (see FIG. 19) incorporates an extension 411A attached to a side edge of the front panel 411 of the box 41, and this extension may be provided with adhesive so that, when the blank is folded up to form the box and the front flap, the extension 411A forms an adhesive connection between the front panel 411 and the fourth edge panel 417, such that the hinge line 431 between the front panel 411 of the box 41 and the front flap 43 is positioned along a side edge of the front panel 411.

The hinge line 431 incorporates a plurality of longitudinal cuts 431A-C which help to accurately define the location of the hinge line 431 and to reduce the resistance of pivoting of the front flap 43 relative to the box 41.

The front flap 43 has, on its front face 432, a rectangular array of first to fourth retaining tabs 433A-D which enable the booklet 5 to be releasably secured to the front face 432. Each retaining tab 433A-D is formed by a cut line 434 in the front flap 43 and may be flexed outwardly along a fold line 435 relative to the plane of the front face 432. This flexing may assist with inserting the booklet 5 behind the retaining tabs 433A-D and with then gripping the booklet to hold the booklet in position on the front of the container 4. The flexing may also subsequently assist with removing or detaching the booklet 5 from the container 4.

Each cut line 434 has a curved shape so as to impart a convexly curved shape to the free edge of the respective one of the retaining tabs 433A-D. For each cut line 434, the associated fold line 435 extends between the ends of the cut line. The sides or longitudinal edges of each cut line 434 are parallel and have complementary or common shapes.

The first retaining tab 433A and the third retaining tab 433C point towards the closed end 32 of the sleeve 3 when the container 4 has been inserted in the sleeve, and these two tabs are positioned side by side in a direction transverse to the insertion/removal axis 33.

The second retaining tab 433B and the fourth retaining tab 433D point towards the open end 31 of the sleeve 3 when the container 4 has been inserted in the sleeve, and these two tabs are also positioned side by side in a direction transverse to the insertion/removal axis 33.

The group comprising the opposed first and second retaining tabs 433A, 433B and the group comprising the opposed third and fourth retaining tabs 433C, 433D are symmetrical relative to the insertion/removal axis 33 (see FIG. 19).

The booklet 5 is rectangular and matches (but is slightly smaller than) the rectangular shape of the array of first to fourth retaining tabs 433A-D. The booklet 5 may be held by the retaining tabs at a central position on the front face 432 of the front flap 43, with each of the retaining tabs 433A-D releasably securing a respective portion of the periphery of the booklet 5. These first to fourth peripheral portions 51-54 of the booklet 5 are shown on FIG. 1. The width of the booklet 5 is less than the width of the front face 432 of the front flap 43 occupied by the first and third retaining tabs 433A, 433C and is also less than the width of the front face 432 occupied by the second and fourth retaining tabs 433B, 433D. Thus, the corners of the booklet 5 are protected from being damaged by being covered by the retaining tabs 433A-D.

The product 6 may be sold in different countries (different markets) around the world, and each market may require its own specific version of the booklet, for example in the local language(s) appropriate for the market in question. The manufacturer of the product 6 may therefore produce a range of different market-specific booklets, and whilst using the same container 4 for all markets the manufacturer may affix the correct market-specific booklet to the front of the container 4 prior to inserting the container in the sleeve (which may also be market-specific, such as in terms of any printing on the outside of the sleeve).

The booklets for different markets may also vary in ways other than just in relation to the language used for the text printed in the booklet. Some markets may require more information to be included, and thus the booklets for different markets may have different numbers of pages.

The front flap 43 includes first and second side tabs 436A, 436B on the free edge of the flap which is remote from the hinge line 431. The side tabs 436A, 436B are releasably engageable with corresponding slits (cut lines) 418A, 418B in the underlying edge of the box 41 when the front flap 43 has been closed, so that the front flap 43 is held closed by this engagement.

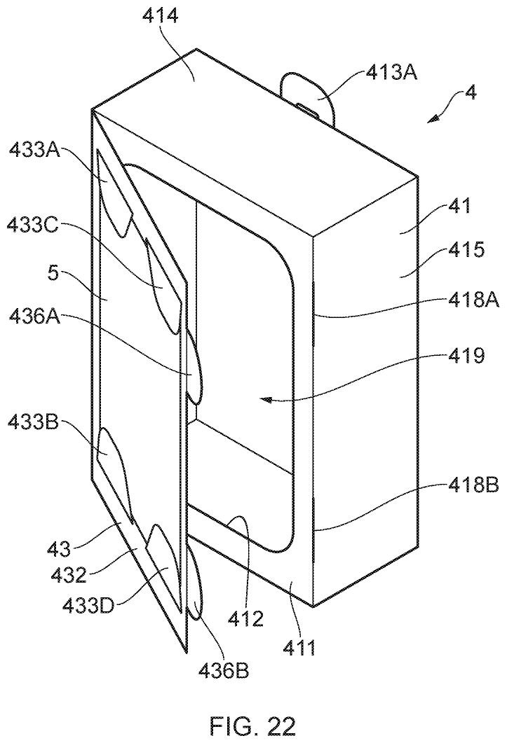

FIG. 22 shows the container 4 without the tray 42 inside the box 41 such that the internal empty cavity 419 of the box 41 is visible.

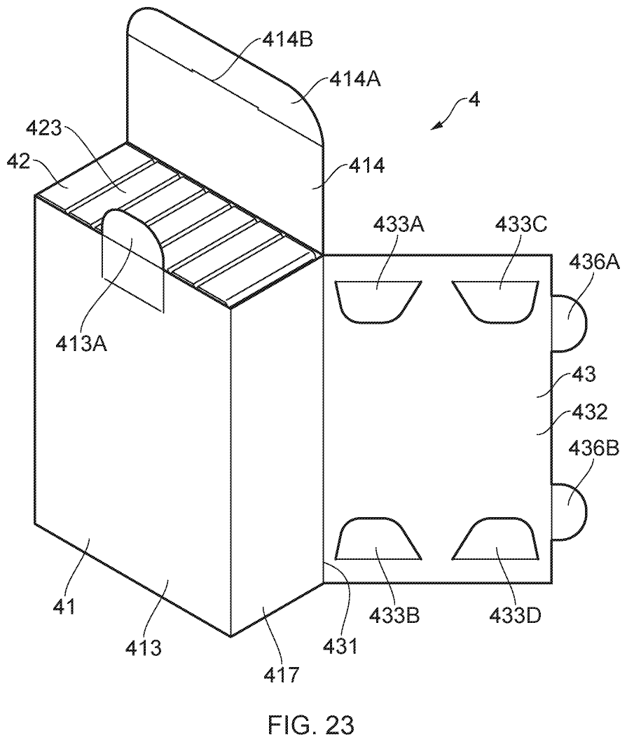

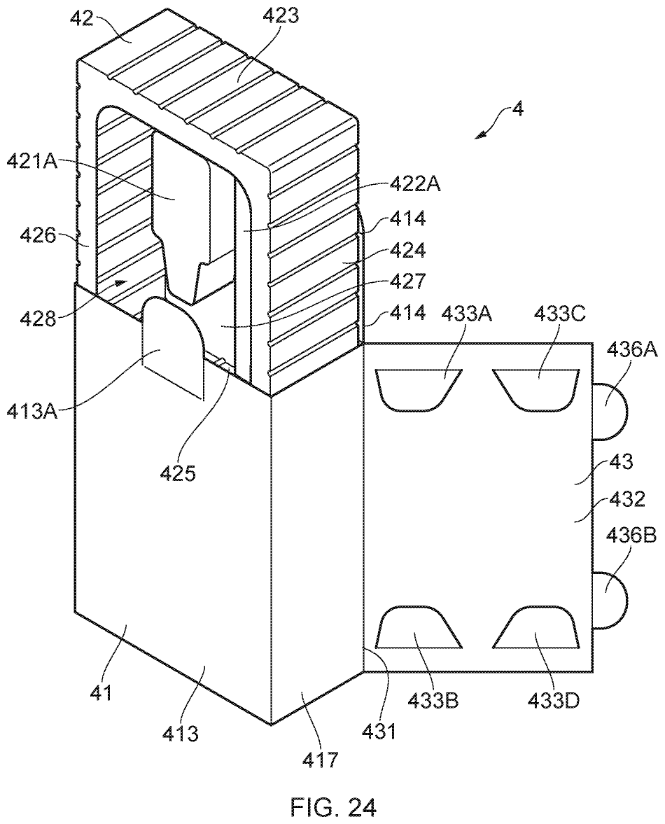

The way in which the tray 42 may slide in and out of the box 41 will now be described in more detail with reference to FIGS. 23 and 24 which are rear perspective views of the container 4 showing an initial stage (FIG. 23) of accessing the top of the tray 42 in the container and a later stage (FIG. 24) when the tray 42 has been partially raised up out of the container to give access to a second compartment behind the tray in which an ancillary item 7 may be stored.

The tray 42 is made of molded plastic material and has dimensions (height, width and depth) which conform to the shape of the internal cavity 419 of the box 41. Thus, when the tray 42 is inside the box 41, the tray 42 is sandwiched between the front and rear panels 411, 413 of the box. The tray 42 is also held in position laterally by close proximity to the first to fourth edge panels 414-417 of the box 41.

In FIG. 23, a start has been made on the process of lifting the tray 42 up out of the box 41. The locking tab 413A has been released from the slit 414B of the top panel 414 of the box 41, and the top panel (the top flap) 414 has been opened in order to gain access to the tray.

The tray 42 comprises first to fourth side walls 423-426 which support a platform surface 427 behind which is an internal cavity 428 which provides a second or rear compartment of the container 4. The front face of the tray 42 is provided by the platform surface 427, and the platform surface 427 has molded in it the first and second wells 421, 422 which provide the first or front compartment of the box 41 (see FIG. 12).

As previously mentioned, the first part 61 of the product 6 may be stored in the first well 421, and the second part 62 of the product 6 may be stored in the second well 422. An ancillary item 7 such as a charger for the product 6 may be stored in the rear compartment 428 behind the platform surface 427. By raising up the tray 42 (moving from the configuration of FIG. 23 to the configuration of FIG. 24) access may be gained to the rear compartment 428 and the ancillary item 7 may be removed so that it may be used.

In FIG. 24, the bottom surface 421A of the first well 421 is visible and the bottom surface 422A of the second well 422 is visible. The depths of the wells 421, 422 match the depths of the first and second parts 61, 62 of the product 6, and the depths of the wells 421, 422 are less than the overall depth of the tray 42.

A manufacturer may produce a range of different products 6 (either unitary, or made up of parts like the first and second parts 61, 62) with the range of products having different shapes and depths. The overall depth of the tray 42 may be made greater than the greatest depth required by any product in the range of products. Thus a range of different customized trays may be molded to suit the different products, but each tray in the range may be fitted in the same internal cavity 419 of the box 41. Thus, the same box 41 with front flap 43 (and thus also the same sleeve 3 and the same display carton 1) may be used for each product in the range of products. This produces a significant cost saving, as the only structurally customized item required for a product in the range of products is a customized tray 42.

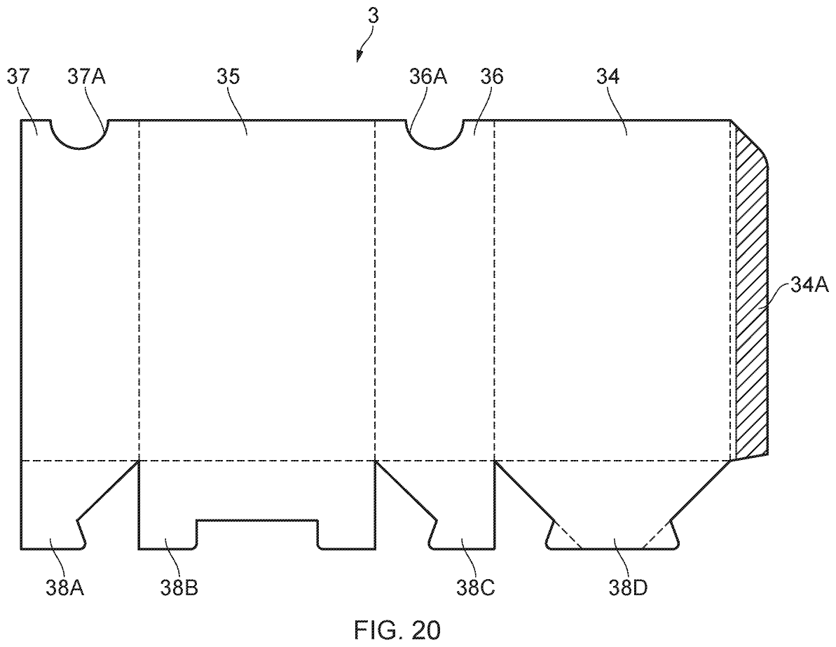

The sleeve 3 will now be described in more detail with reference to FIGS. 1 and 3A which show the sleeve 3 in perspective view. Reference will also be made to FIG. 20 which shows a single blank which is made of thin card and which may be folded up to form the sleeve 3.

The sleeve 3 comprises front and rear main panels 34, 35 and first and second side panels 36, 37 and a bottom 38 which is made up of four sections 38A-D which lock together to form the closed bottom end 32 as the blank is folded up to form the sleeve 3. The top edges of the side panels 36, 37 each include a cutout 36A, 37A to facilitate the user in gripping a container 4 inside the sleeve 3 so that the container 4 may be lifted up out of the open top end 31 of the sleeve.

The sleeve 3 includes an extension 34A attached to a side edge of the front panel 34, and this extension may be provided with adhesive so that, when the blank is folded up to form the sleeve, the extension 34A forms an adhesive connection between the front panel 34 and the second side panel 37.

The inside of the sleeve 3 is free of any internal restraining structure that might prevent the complete removal of the container 4 from the sleeve. In particular the internal faces of the front and rear main panels 34, 35 and first and second side panels 36, 37 do not incorporate any edge which is transverse to the insertion/removal axis 33 and which might snag on one of the retaining tabs 433A-D of the front flap 43 as the container 4 is inserted into or extracted from the sleeve 3.

The sleeve 3 operates in a “vertical loading” mode in relation to the container 4 and has a closed bottom end 32. This means that there is only one opening (at the top end 31) and this opening may be closed with a tax stamp placed across the opening. The tax stamp may be in the form of a band or strip 39 and may incorporate tamper-evident features. The tax stamp 39 may serve as an additional print-bearing surface on which market-specific information may be printed and/or on which product-specific information may be printed which relates to the particular product 6 which is included in the packaging.

When the packaging arrives at its destination, it looks like in FIG. 1. Then, the cover 12 of the display carton 1 may be removed, by rupturing the lines of weakness 125B-D (and probably also the line of weakness 125A). The packaging then looks like in FIG. 2. A selected one of the product kits 2 may be removed from the base tray 11 of the display carton 1. The product kit 2 may then be opened. As shown on the left side of FIG. 3A, the tax stamp 39 may be removed from the sleeve 3. At this point in time, the container 4 is still inside the sleeve 3, and the booklet 5 on the front of the container 4 is covered by the sleeve 3.

As the container 4 is lifted out of the sleeve 3, the booklet 5 becomes accessible and it may be removed from the front flap 43 of the container 4 by lifting up one or more of the retaining tabs 433A-D. The front flap 43 may be pivoted from its closed position to an open position, and the product 6 (the first and second product parts 61, 62) may be removed from the first and second wells 421, 422 of the tray 42.

When the container 4 was in the sleeve 3, the locking tab 413A was covered by the sleeve 3 and was not accessible. With the container 4 removed from the sleeve 3, the locking tab 413A is accessible and it may be pivoted rearwardly so that it disengages from the slit 414B of the top flap 414 (the top panel) of the box 41. The top flap 414 may then be opened, and the tray 42 may be lifted up out of the box 41 to gain access to the rear compartment 428 underneath the tray 42, so that the ancillary item 7 may be removed for use in conjunction with the product 6.

The product 6 and the ancillary item 7 may be returned to the front compartment (wells 421, 422) and the rear compartment 428 respectively. The booklet 5 may be re-attached to the front of the container 4 by being tucked back underneath the retaining tabs 433A-D and the front flap 43 may be closed, and then the container 4 may be slid back down into the sleeve 3.

During the removal of the container 4 from the sleeve 3, and during the re-insertion of the container 4 into the sleeve 3, the booklet 5 and the retaining tabs 433A-D will not snag or catch on the internal surface of the sleeve 3 because the main walls of the internal surface are free of transversely extending edges projecting into the cavity of the sleeve 3.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A display carton comprising:
a base tray having an upstanding front wall, upstanding side walls, and an upstanding rear wall; and
a cover which is detachably connected to the base tray along lines of weakness, the cover including an inner front wall positioned above the upstanding front wall of the base tray, and an outer front wall which is provided by a distal end of a forwardly extending lid of the cover;
wherein the inner front wall comprises a left portion and a right portion which are connected together by a line of weakness; and
wherein a bottom end of the outer front wall is tucked into a slot formed between a bottom edge of the inner front wall and a top edge of the upstanding front wall of the base tray.

2. The display carton according to claim 1, wherein the slot has a triangular shape.

3. The display carton according to claim 1, wherein bottom edges of the left portion and the right portion of the inner front wall of the cover slope upwards and meet at a bottom end of the line of weakness connecting together the left portion and the right portion of the inner front wall.

4. The display carton according to claim 1, wherein the top edge of the upstanding front wall of the base tray is substantially horizontal.

5. The display carton according to claim 1, wherein the cover has a first side wall and a second side wall each having a bottom edge connected by a respective one of the lines of weakness to a top edge of a respective one of the upstanding side walls of the base tray.

6. The display carton according to claim 5, wherein the first side wall and the second side wall of the cover are each connected at a top edge to a respective flap which is pivotable between a position in which the flap extends inwards to be underneath the lid of the cover and a position, when the lid has been opened, in which the flap extends outwards away from the lid.

7. The display carton according to claim 1, wherein:
the upstanding rear wall of the base tray is taller than the upstanding front wall of the base tray; and
top edges of the upstanding side walls of the base tray each slope downwards from the upstanding rear wall to the upstanding front wall of the base tray.

8. The display carton according to claim 1, wherein a rear wall of the cover is hingedly connected to a proximal end of the lid of the cover and is connected by one of the lines of weakness to a top edge of the upstanding rear wall of the base tray.

9. Packaging comprising the display carton according to claim 1 and a plurality of box-like product kits which are stored one in front of another inside the display carton.

10. The packaging according to claim 9, wherein a height of each of the box-like product kits matches an inside height of the display carton when closed and a width of each of the box-like product kits matches an inside width of the display carton, and combined depths of the plurality of box-like product kits matches an inside depth of the display carton between the upstanding front wall and the upstanding rear wall of the base tray of the display carton.

11. A blank for forming the display carton of claim 1.

12. A method of forming a display carton, comprising:
providing a blank for a display carton; and
folding the blank to form the display carton of claim 1.
